(19) United States
(12) Patent Application Publication
(10) Pub. No.: US 2005/0254405 A1
(43) Pub. Date: Nov. 17, 2005

(54) Multi-layer optical storage using pre-orientation in a glass matrix

(75) Inventors: Emiel Peeters, Eindhoven (NL); Dirk Jan Broer, Eindhoven (NL); Christopher Busch, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/517,927

(22) PCT Filed: Jun. 4, 2003
(86) PCT No.: PCT/IB03/02358

§ 371 Date: Dec. 14, 2004

(30) Foreign Application Priority Data
Jun. 19, 2002 (EP) 02077424.6

(51) Int. Cl. G11B 7/00; G11B 7/24

(52) U.S. Cl. 369/275.1; 369/100

(57) ABSTRACT

The invention relates to producing an optical memory which combines stability of written and non-written data with high writing speed and good sensitivity during writing, such an optical memory as well as a method of writing in such a memory. The optical memory has a liquid crystal (LC) layer with a first type of LC molecules (102) aligned in one direction, forming a polymer network (108), and a second type of LC molecules (104) oriented in a perpendicular direction, in which the orientation of said second type of LC molecules is meta-stable. By making use of a force, exerted on the second type of LC molecules (104), by the network of aligned crosslinked molecules, an increase in relaxation rate for the second type of molecules (104) from a meta-stable state of orientation, is achieved, which makes it possible to use said relaxation for writing data at an increased writing rate.

The present invention relates in general to optical storage devices and in particular to a computer readable medium using pre-orientation in a glass matrix for optical storage of data and a method to produce said medium.

It is well known in the field of optical storage of data to use liquid crystal molecules having a glass transition temperature. For instance document U.S. Pat. No. 5,976,638 concerns an optical recording medium comprising a homeotropically oriented liquid crystalline polymer film containing liquid crystal molecules having a glass transition temperature T_{g}, and dichroic dye molecules, both being oriented perpendicular to the surface of the film.

In general, the absorption dipole moment of a dichroic dye coincides with the the long axis of the chromophore and therefore, the absorption of dichroic dye molecules is clearly directional.

In a non-written film the liquid crystal molecules and hence the dichroic dye molecules are homeotropically oriented and show only low absorption of the incident light. By local heating or by irradiating (e.g. by a laser) to a temperature above the glass transition temperature, T_{g}, of the liquid crystal molecules said homeotropically orientation is converted into an isotropic one. As the irradiated or heated areas are cooled off rapidly (below the T_{g} of the liquid crystal crystalline polymer), the isotropic orientation is frozen in. As the dichroic dye will likewise be isotropically oriented, this results in a substantially higher absorption of the incident light.

A disadvantage of this method is the long relaxation time of the LC molecules, during which entire length the trace (or data pit) that is written has to be kept at a temperature above the glass transition temperature (T_{g}), when used for information storage.

A further disadvantage is the need to rapidly cool off the written area to a temperature below the glass transition temperature, in order to freeze in the isotropically oriented dichroic dye molecules.

A limitation of this method is the need to utilize a dichroic dye, in order to create an absorption contrast for the incident light.

It is also known (in the field of liquid crystal displays) to use a dilute anisotropic liquid crystal polymer network. The anisotropic LC polymer network itself is typically made of crosslinked liquid crystal molecules in the presence of an abundant second type of liquid crystal molecules, both types being aligned in a direction determined for instance by an alignment layer. The network exerts a force on the second type of LC molecules, anchoring them to the network. Still, by applying an electric field it is possible to orient the second type of LC molecules in a second direction. However, upon switching off said external field, the network force drives the second type of molecules back to their initial orientation, making their second orientation unstable.

A limitation of the described method for optical storage of data is that the state of orientation of the LC molecules oriented by the applied external field, i.e. the second orientation, is unstable, requiring said external field being switched on in order to prevent said LC molecules from relaxing and reorienting. This method can however be utilized for information storage by equipping each storage layer with electrodes and by locally destroying said electrodes upon writing information. Therefore, LC molecules in non-written data pits only, will be affected by the applied electric field and forced to change their orientation when addressed upon reading. A drawback of this method is the usage of electrodes which makes this implementation complex and expensive.

An object according to a first aspect of the present invention is to provide an optical memory which combines stability of written and unwritten data with high writing speed and good sensitivity during writing.

According to said aspect this object is achieved by a method for producing a computer readable medium for optical storage of data, comprising the steps of applying, onto a substrate, a mixture comprising liquid crystal molecules of a first type and liquid crystal molecules of a second type, said liquid crystal molecules of a second type being associated with a glass transition temperature and a clearing temperature, for providing a glassy LC layer, heating the glassy liquid crystal mixture to a temperature above the glass transition temperature, providing alignment of the liquid crystal molecules in a first direction, supplying radiation to the LC layer and thereby the liquid crystal molecules in order to form a liquid crystal polymer network of the first type of liquid crystal molecules, applying an electric or magnetic field to the LC layer, causing orientation of the non-reactive liquid crystal molecules in a second direction, and cooling said LC layer to a temperature below said glass transition temperature during the application of said electric or magnetic field, so that a meta-stable state of orientation of liquid crystal molecules is established in said medium.

By successfully selecting LC molecules having a glass transition temperature as the second type of liquid crystal molecules, the problem of instability of the trapped LC molecules in a dilute anisotropic LC polymer network is solved. The method for producing a computer readable medium according to the present invention successfully produces LC molecules trapped in a meta-stable state of orientation in the dilute anisotropic LC polymer network.

This object is also achieved by a computer readable medium for optical storage of data comprising, an LC layer, including a first type of liquid crystal molecules aligned in one direction and forming a polymer network, and a second type of liquid crystal molecules oriented in a second direction, in which the orientation of said second type of liquid crystal molecules is meta-stable.

The present invention comprises the successful utilization of liquid crystal molecules having a glass transition temperature to be oriented and frozen in to establish a meta-stable state of orientation in a dilute LC polymer network.

Due to the usage of a dilute LC polymer network according to the first aspect of the present invention, the problem of too low a relaxation rate for the orientation of LC molecules, is overcome. The force that is exerted on the second type of LC molecules by the dilute LC polymer network, forcing said second type of LC molecules to reorient and adopt a low energy orientation determined by the alignment layer, increases the relaxation rate of said second type of liquid crystal molecules.

Since the written state of a computer readable medium, according to the present invention, is a state to which the second type of liquid crystal molecules have relaxed, this state is consequently a lower energy state, having a high stability. The stability of the stored information is thus increased using the method of the invention. Nevertheless, both the written and non-written bits are stable as a result of the immobility of the second type of LC molecules when the medium is kept at a temperature below T_{g}.

The LC polymer network made of the polymerized first type of liquid crystal exerts a strong driving force on the second type of liquid crystal molecules in their meta-stable state of orientation. Once the temperature of the addressed data bit(s) is increased above the glass transition temperature, using for instance a laser or by local heating, the network forces the second type of LC molecules to reorient into their relaxed state, thereby increasing the relaxation rate of said second type of LC molecules. This thus enables a high rate data storage.

The relaxation time (switching time) of the second type of molecules in the storing process is reduced to the order of microseconds, to be compared with the standard reorientation time of the order of milliseconds, in the absence of a LC polymer network exerting such a driving force. Hence the invention requires less energy (laser pulses of the order of nanoseconds) to write data. The probability of thermal crosstalk is furthermore reduced as the time during which the temperature of the addressed data bits upon writing, has to stay above the glass transition temperature, is reduced.

The computer readable medium according to the dependent claim 2 has the advantage that the relative percentage of the first and second type of liquid crystal molecules is favorable for a dilute LC polymer network. It is estimated that at least 0.1% by weight of said first type of LC molecules is required to form such a dilute anisotropic LC polymer network. Further, 10% by weight is estimated to be an upper concentration limit of the LC molecules of the first type in order to form a network being dilute. A lower and an upper concentration of 80 and 99.9%, respectively, by weight are estimated limits for a proper function of the computer readable medium of the present invention.

The use of oriented anisotropic fluorescent molecules (i.e. fluorophores) in storage principles enables an increased absorption cross section when reading the storage medium. With perfectly aligned fluorescent molecules, the absorption cross section is increased three times as compared with fluorescent molecules being isotropically oriented. By rotating the aligned fluorescent molecules by 90°, a contrast of 1:7 in absorption and thus in fluorescence emission is realistic.

The computer readable medium according to the dependent claim 5, and the method according to the dependent claim 7, have the advantage that reading of the computer readable medium can be done by fluorescence, i.e. by excitation of the chromophores and detection of the emitted fluorescent light. Further advantages by using fluorescent chromophores are described above.

In the case of writing information in the homeotropically oriented liquid crystalline polymer film as described in the prior art above, said film needs to be kept at a temperature above the glass transition temperature during the entire relaxation from the homeotropical orientation to the isotropical orientation. As this relaxation time is relatively long, a memory based on this technique will consequently receive a relatively low writing speed.

An object according to a second aspect of the invention, is directed towards providing a method of writing information using liquid crystals, which overcomes the problem of too low a writing speed.

According to this second aspect this object is solved by a method of writing data into a computer readable medium, in which heat is applied during a short duration in time, e.g. by using a heat pulse, to the area of the LC layer where the bit is to be written in order for said data bit to reach a temperature, T, for which T is above T_{g}, such that the temperature of said area stays above the glass transition temperature, T_{g}, during the entire relaxation of the second type of LC molecules, i.e. during the switch from the meta-stable state to a low energy state of orientation.

Due to a poor heat conductivity of the computer readable medium, a nanosecond-long heat pulse is sufficient to allow an entire switch in orientation during a time span in the order of micro seconds.

In the manner described above, using heat pulses having a length in the order of nanoseconds, the writing process, i.e. storage of data, receives an excellent rate performance.

The above described method of writing data will thus benefit from said rate performance.

These and other aspects of the invention will be apparent from and elucidated with reference to the embodiments described hereinafter.

These and other features and advantages of the present invention will be better understood by reference to the following detailed description when considered in conjunction with the accompanying drawings wherein:

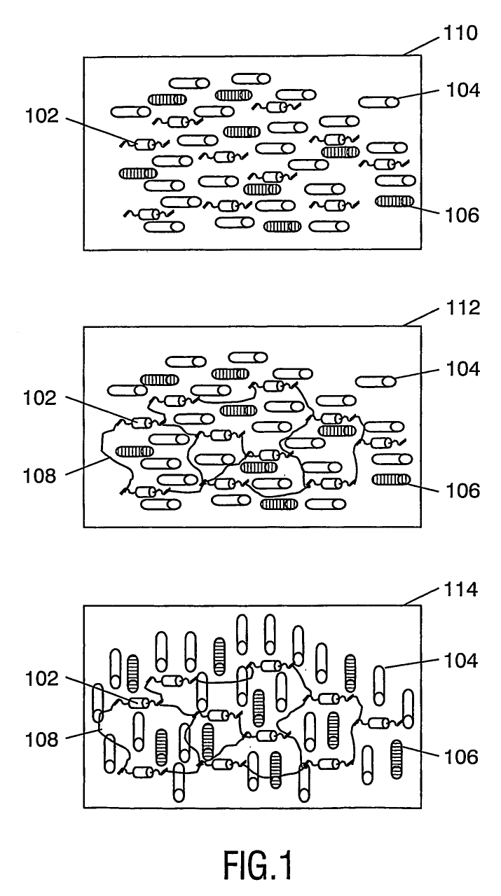

FIG. 1 shows an upper, a middle, and a lower panel that schematically illustrate different states that are passed during the formation of an LC layer containing LC molecules in a meta-stable orientation, tapped in a dilute oriented liquid crystal polymer network.

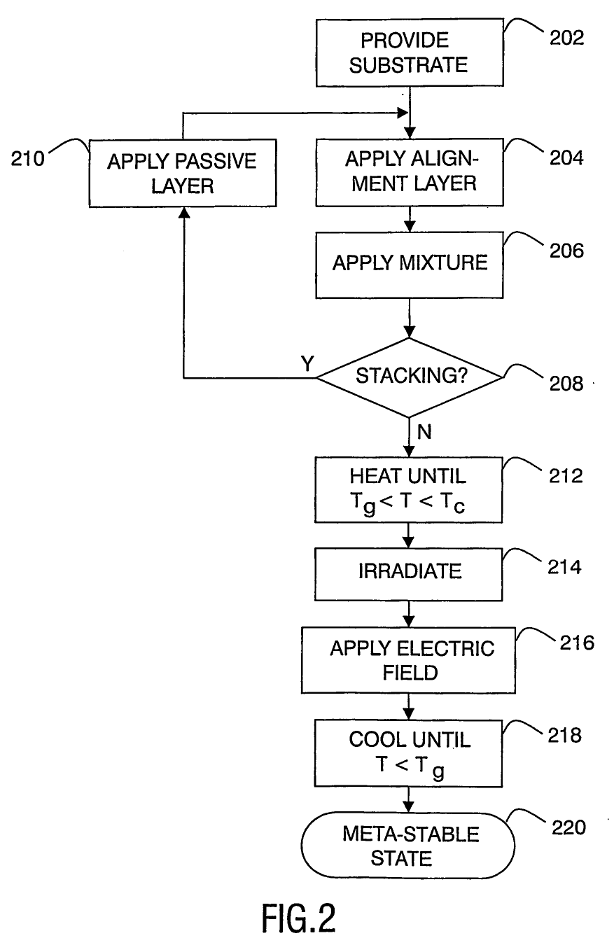

FIG. 2 shows a flow-chart of a preferred embodiment method to manufacture a computer readable medium for optical storage of data.

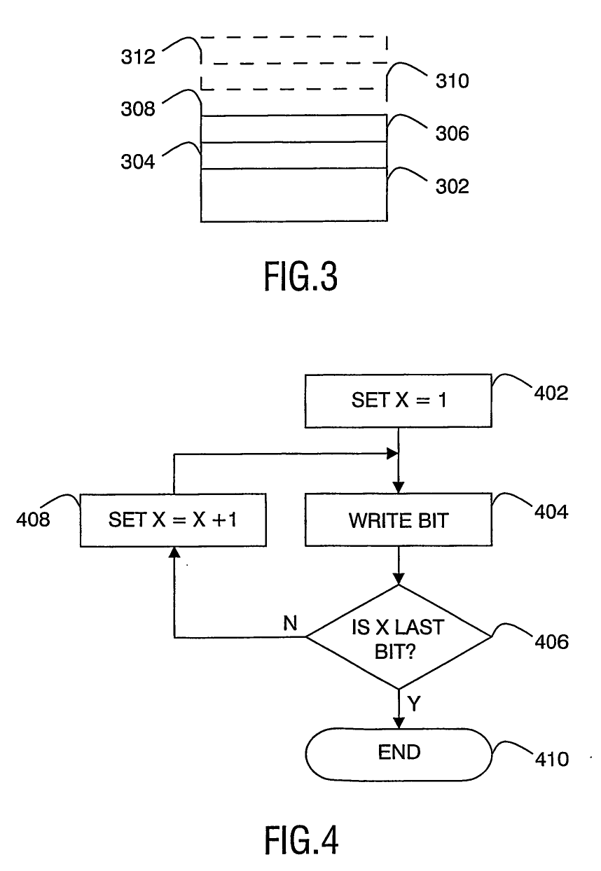

FIG. 3 depicts the construction of a multi-layered computer readable medium for optical storage of data.

FIG. 4 shows a flow-chart of a method of writing data into a computer readable medium.

The present invention relates to the provision of optical computer readable mediums and in particular to optical memories using anisotropic polymer networks.

Reference will now be given to the upper, middle and lower panels of FIG. 1 illustrating the different states that are passed during the formation of a dilute liquid crystal (LC) layer containing LC molecules in a meta-stable orientation, for the provision of a computer readable medium according to a preferred embodiment. Such an LC layer can be obtained by first applying a mixture onto a substrate that is pre-coated with an alignment layer. This mixture is prepared by dissolving a few percent of a first type of liquid crystal molecules, 102, with the ability to crosslink to each other, i.e. they are reactive, an amount of dichroic fluorescent dye molecules, 106, and a second type of liquid crystal molecules, 104, in a solvent. This state is schematically illustrated in the upper panel of FIG. 1. Upon raising the temperature above the glass transition temperature of the second type of liquid crystal molecules, and below the clearing temperature of the same molecules, the first and second type of liquid crystal molecules align themselves in a direction defined by the underlying alignment layer.

By polymerization of the first type of LC molecules, 102, a polymer network, 108, of aligned LC molecules is formed, as shown in the middle panel of FIG. 1. The orientation of said aligned first type of LC molecules, 102, is maintained in the formed anisotropic polymer network, 108, and defines the orientation of the same network.

A strong anchoring of the second type of LC molecules, 104, to the anisotropic LC polymer network, 108, is thus obtained and the orientation of the LC molecules will thus be determined by the orientation of the LC polymer network, 108. Nevertheless, under external fields (e.g. electric fields or magnetic fields) it is still possible to change the overall orientation (deform the director profile) of the second type of LC molecules, 104, and the dichroic fluorescent dye molecules, 106, to achieve a second overall orientation, different from first orientation of these molecules, which is shown in the lower panel of FIG. 1. The orientation of the anisotropic LC polymer network, 108, itself is not changed by the application of this field. Due to the strong anchoring of the LC molecules, 104, to the LC polymer network, 108, thus obtained, the deformation of the director profile will result in a substantial increase of the deformation energy. Upon switching off the applied external field, the high deformation energy drives the second type of LC molecules, 104, to relax to, or close to, their original orientation, coinciding with the orientation of the LC polymer network, 108. This relaxation reorientation of abundant molecules forces the dichroic fluorescent dye molecules, 106, to change their orientation accordingly. The force exerted by the anisotropic polymer network increases the relaxation rate, as compared to the case where there is no LC polymer network present and anchoring of the LC molecules is performed at an alignment layer only.

However, by using liquid crystal molecules associated with a glass transition temperature, T_{g}, as the second type of LC molecules, 104, and by decreasing the temperature to a temperature below T_{g}, prior to switching off said external field, the second orientation of said second type of LC molecules, 104, and the dichroic fluorescent dye molecules, 106, is frozen in and maintained. Obtained is thus a polymer network, 108, aligned in one direction and a second type of liquid crystal molecules, 104, and fluorescent dye molecules, 106, oriented in a second direction, as is schematically shown in the lower panel of FIG. 1. The state of orientation of the second type of LC molecules, thus achieved is a meta-stable state of orientation.

Molecules with the ability to adopt a meta-stable state can be used for storage of data. Upon writing of a data bit, the molecules in a meta-stable orientation of this bit, return to their original orientation, whereas the molecules of non-written data bits stay in their meta-stable orientation.

Due to the different orientation of the liquid crystal molecules in the written and non-written bits, these show slightly different refractive index. For a reason that will become obvious later on in the description, in this embodiment this difference is however minimized at the production stage of the computer readable medium.

Thus a computer readable medium according to a preferred embodiment has been described.

A preferred method of producing an optical storage medium according to the invention will now be described in relation to FIG. 2.

Onto a provided substrate, step 202, an alignment layer is applied, step 204, to align molecules to be applied onto said substrate. A mixture comprising two different types of liquid crystal molecules, one of which has the ability to form a network upon irradiation with for instance ultra-violet (UV) light, and the other has not, is subsequently applied on top of the alignment layer on the substrate in order to form an LC layer, step 206. Said mixture also comprises fluorescent dye molecules and photoinitiator molecules, (not shown).

In the case more than one LC layer is to be provided, “Y” is chosen at step 208, i.e. when a stack of layers is to be provided, a passive layer is applied, step 210, followed by the previously mentioned steps 204-206. This is repeated until a stack of a desired number of LC layers has been obtained, and hence the alternative “N” at step 208, as an answer to “stacking?” is chosen.

Subsequently, the LC layer(s) is/are heated to a temperature, T, that is above the glass transition temperature, T_{g}, of the liquid crystal mixture applied and below the clearing temperature, T_{c}, of said mixture, step 212. At this stage at the temperature, T, the two types of liquid crystal molecules and the fluorescent dye molecules are aligned and oriented in the direction as determined by the alignment layer. While keeping the whole structure or sample at said temperature T, said sample is irradiated by UV-light, step 214, causing the first type of liquid crystal molecules to crosslink with each other, forming a polymer enforced LC layer.

Maintaining the sample at temperature T, an electric field is applied over said sample, e.g. by conveniently using a corona discharge, causing the second type of liquid crystal molecules to change their orientation into a direction substantially perpendicular to the direction of said network, step 216. Subsequently the sample is cooled to a temperature below said glass transition temperature T_{g}, step 218. A computer readable medium containing a meta-stable state of orientation in which the second type of liquid crystal molecules are oriented preferably perpendicular to the direction of the anisotropic LC polymer network, is thus obtained, step 220, as is schematically illustrated in the lower panel of FIG. 1.

This thus provided medium is schematically depicted in FIG. 3, showing a side-view of the different layers of the structure, in which the substrate, 302, is covered by an alignment layer, 304, onto which the polymer enforced glassy LC layer, 306, containing the anisotropic LC polymer network, the second type of liquid crystal molecules in a meta-stable state of orientation and the dichroic fluorescent molecules, are provided. If more than one polymer enforced glassy LC layer is to be applied, an inert passive layer, 308, is provided onto the glassy LC layer, 306, followed by an alignment layer, 310, and another glassy LC layer, 312, as indicated in FIG. 3 by broken lines. The steps corresponding to the application of these three layers can be repeated until the desired number of layers has been obtained.

The usage of the computer readable medium for optical storage of data will now be explained:

Information is stored by focusing a laser (or by local heating) onto a glassy LC layer, containing the meta-stable state of orientation. In focus, the light beam causes the local temperature at the illuminated point to increase above the glass transition temperature, causing a phase transition for the second type of liquid crystal molecules from the glassy phase to a liquid crystalline or liquid phase with the consequence that the meta-stable state of the second type of liquid crystal molecules vanishes and said liquid crystal molecules relax and adopt an orientation directed according to the LC polymer network. This corresponds to the writing of one bit or a bit-transition. A written bit then, for example, corresponds to a “zero” whereas a non-written bit corresponds to a “one”. The second type of liquid crystal molecules of the written data bits are thus aligned in the direction of the LC polymer network, whereas the non-written data bits are not, but rather oriented in a direction perpendicular to the direction of said network, in the meta-stable state.

Another aspect of the invention is directed towards overcoming the problem of too low a writing speed, making use of the poor heat conductivity of the polymer enforced LC layer, will now be described with reference given to FIG. 4.

The method begins by setting a counter's value, X, to 1, step 402. For every data bit that is to be written, step 404, it is determined whether this data bit is a “one” or a “zero”. For either “one” or “zero” heat is applied to an area of the LC layer to be written by a laser pulse or a heating device, in order for the addressed area to reach a temperature, T, above T_{g}, and thereby writing said data bit. If all data bits that are to be written have been written, step 406, i.e. the counter's value, X, has reached the final number (last data bit), the method is ended, step 410. If all data bits have not been written, step 406, the counter's value, X, is set to X+1, step 408, the laser beam is moved to another area, or alternatively the heating device is arranged, to heat another area, whereby steps 404 and 406 will be repeated. For the bits requiring heating, the temperature, T, to which the addressed data area is heated, is adjusted such that the relaxation of the second type of liquid crystal molecule is substantially accomplished in the time span during which the temperature of the addressed area decreases to the glass transition temperature, T_{g}. Due to the poor heat conductivity of the computer readable medium, a heat pulse with a length in the order of nanoseconds is sufficient to allow a substantially complete switch in orientation (relaxation) within a time span in the order of micro seconds. Hence, by using nanosecond-long heat pulses, a high data rate for writing is enabled.

Reading of the written and non-written data bits can be done on the bases of differences in refractive indices, absorption or fluorescence. In the case of fluorescence, reading is e.g. performed by excitation of dichroic fluorescent molecules, and subsequently detection of the emitted fluorescent light. Fluorescent molecules are excited according to their absorption cross section. Fluorescent molecules oriented in different directions will thus be excited to different extents, leading to differences in the intensity of the emitted light—thus corresponding to different types of information stored (ones and zeroes).

As previously indicated the refractive index between molecules in written and non-written bits differ slightly. If more than one glassy LC layer is present in the data storage medium any difference between the refractive index of written and non-written bits will reduce the quality of the beam for the underlying layers and therefore also the performance of the data storage medium. In single layer systems, reading based on the difference in refractive index or absorption between written and non-written bits, is equally suitable compared to fluorescence. In the case with several glassy LC, passive, and alignment layers alternately stacked onto each other, it is advantageous to minimize this refractive index difference. Fortunately one embodiment of this invention involving dichroic fluorescent chromophores enables a careful choice of materials in order to minimize said refractive index difference and thus opens up for an optical storage medium having a multi-layer architecture.

The invention can be varied in many ways, for instance:

In a second embodiment of the present invention the method for producing the computer readable medium, stacking is performed by applying an alignment layer, applying the mixture, comprising the LC molecules, onto the substrate, heating the applied mixture to a temperature above T_{g} and below T_{c}, and irradiating the sample by UV-light, causing polymerization, prior to applying an inert passive layer. Thereafter, the steps in this paragraph are repeated until a desired number of LC layers has been obtained, creating a multi-layer optical storage medium. In this embodiment the sample is preferably cooled to a temperature, T, below T_{g}, just before applying the inert passive layer.

In yet another embodiment, stacking is obtained by processing thin transparent substrates individually with alignment, active and passive layers, prior to stacking the processed substrates together to achieve a multi-layer optical storage medium.

In a different embodiment of the present invention, the computer readable medium having several LC layers, i.e. a multi-layer computer readable medium, contains pre-written data in at least one of said LC layers.

In a yet another embodiment of the present invention, a method to produce a multi-layer computer readable medium having at least one pre-written LC layer, comprises the application of a hot stamp, having a writing bit pattern corresponding to the data that is to be written, onto the polymer enforced LC layer containing LC molecules of the second type in a meta-stable orientation state. Upon applying this pre-patterned stamp, the data areas corresponding to the writing bit pattern of the stamp, which are to be heated, are heated to a temperature above T_{g}, enabling the switch from the meta-stable state to the low energy relaxed state for the second type of LC molecules, i.e. a bit-transition. The second type of LC molecules in the data areas corresponding to the writing bit pattern, which areas are not to be heated, maintain their meta-stable state of orientation. The writing process using a hot stamp, for instance made of metal, is preferably used for simultaneous writing of more than one data bit, i.e. parallel data writing. Any aspects of data writing and/or data replication that benefit from a parallel writing process are possible applications of this writing technique. For instance the manufacturing (and possibly usage) of CD, DVD, laser discs, MD, to mention a few are obvious areas of interest of this embodiment of the present invention.

The above mentioned substrate can for instance be made of polycarbonate or polynorbonene or another material that is suitable for the processing steps exemplified above. Further, said substrate is preferably transparent to the electromagnetic light applied during usage (i.e. writing and reading) of said computer readable storage medium, i.e. visible, ultra violet, infrared light.

In still yet another embodiment of the present invention, the substrate is detachable from the sample being formed, i.e. said substrate merely functions as a support during initial or intermediate processing steps.

The alignment layer applied prior to applying the mixture comprising liquid crystal molecules, serves to align the liquid crystal molecules in one direction. This alignment layer can for instance be a rubbed alignment layer or a photo-alignment layer.

Alignment of LC molecules contained in the LC mixture can furthermore alternatively be achieved by applying an external electric or magnetic field over the sample.

The active mixture is applied to the substrate by using any suitable technique for coating, such as printing, spin-coating, doctor blade coating, dipping, casting, or another industrially controllable coating method.

In another embodiment of the present invention the fluorescent dye molecules comprised in said mixture are substituted by a different type of fluorescent molecules, e.g. fluorescent liquid crystal molecules.

In yet another embodiment of the present invention any storage mechanism that is based on a change in orientation of anisotropic molecules is applicable.

It is also possible to read information stored in the computer readable medium, based on the small refractive index difference between the written and non-written data bits, which in this case is not fully minimized.

A difference in absorption of an illuminated light, causing a difference in reflection can alternatively be used to read the stored information.

Difference in the transparency or transmission of written and non-written bits can also be used for reading the computer readable medium.

For the irradiation of the mixture, comprising the two types of liquid crystal molecules, electromagnetic radiation or electron beam radiation can be used to cause said first type of liquid crystal molecules to crosslink, forming the anisotropic LC polymer network. Within electromagnetic radiation, wavelengths other than ultra-violet light, e.g. visible light, X-rays or gamma radiation can alternatively be used

The state of orientation of said second type of liquid crystal molecules, caused by the application of said external electric field may be different from the preferred substantially perpendicular orientation compared to the direction of the anisotropic LC polymer network of the first type of LC molecules. The effective orientation of the second type of LC molecules is determined by the relative orientation of the LC polymer network and the applied external field.

An alternative aspect of the method for producing a computer readable medium is that the alignment of the liquid crystal molecules at least partly is provided by the technique used to apply the mixture of liquid crystal molecules onto the substrate. These techniques are such as spin-coating, doctor blade coating or printing techniques.

The meta-stable state is enabled by the combination of a first type of LC molecules that can form a dilute polymer network, e.g. LC molecules with reactive groups such as diacrylates, diepoxides, or alike, and a second type of LC molecules that form a glass at room temperature and posses a nematic or a smectic liquid crystal phase at elevated temperatures. This second type of liquid crystal molecule is typically a low molecular weight LC side-chain oligomer, a low molecular weight LC main-chain oligomer or a highly branched LC molecule. The combination of these two types of LC molecules should be optimized to obtain the meta-stable state, enabling writing at a high rate. The dichroic absorbing or fluorescent dyes can be optimized independently as long as they dissolve in the solvent used for the polymer enforced glassy LC layer (LC gel) formed.

With the present invention has thus been described a memory with the following advantages:

The written state is a state to which the second type of liquid crystal molecules have relaxed, and consequently this state is a lower energy state, having a high stability. The stability of the stored information is thus increased using the method of the invention. As mentioned above, both the written and non-written data bits are stable as a result of the immobility of the second type of LC molecules when the medium is kept at a temperature below T_{g}.

The LC polymer network made of the polymerized first type of liquid crystal exerts a strong driving force on the second type of liquid crystal molecules in their meta-stable state of orientation. Once the temperature of the sample is increased above the glass transition temperature, using for instance a laser or by local heating, the network forces the second type of LC molecules to reorient into their relaxed state, thereby increasing the relaxation rate of said second type of LC molecules. This thus enables a high rate data storage.

It is furthermore also possible to heat the active layer upon writing to a temperature above T_{g} by for instance a short laser pulse. When writing the writing beam then moves on to write other bits while the temperature of the first bit stays above T_{g} for a certain amount of time as a result of a poor heat conductivity of the medium. The temperature to which the written areas are heated is adjusted so that the duration for which the temperature of the written area is above T_{g} is sufficiently long to allow a full relaxation of the second type of LC molecules. As a consequence, the laser beam can move on while the reorientation process continues in the written bits as long as the temperature T>T_{g}.

The use of oriented anisotropic fluorescent molecules (i.e. fluorophores) in storage principles enables an increased absorption cross section when reading the storage medium. With perfectly aligned fluorescent molecules, the absorption cross section is increased three times as compared with fluorescent molecules being isotropically oriented. By rotating the aligned fluorescent molecules by 90°, a contrast of 1:7 in absorption and thus in fluorescence emission is realistic.

The use of oriented anisotropic fluorescent molecules further enables anisotropic emission of fluorescent light. As compared with isotropically oriented fluorescent molecules, a factor of three, or realistically speaking a factor of two, is gained in the emission of said light, which can be utilized to improve the collection efficiency, leading to higher data rates.

Because of the aligned orientation of the fluorescent dye molecules, the emission of light is anisotropic which increases the fluorescent signal intensity in one direction.

As a consequence of the alignment of the fluorescent molecules an increased cross section is further made possible.

As the fluorescent dye molecules change their orientation upon writing, fluorescence is practically switched on. Therefore the non-written areas do not contribute to the background, causing a reduction of intervening background light.

The relaxation time (switching time) of the second type of molecules in the storing process is reduced to the order of microseconds, to be compared with the standard reorientation time of the order of milliseconds, in the absence of a LC polymer network exerting such a driving force. Hence the invention requires less energy (laser pulses of the order of nanoseconds) to write data. The probability of thermal cross talk is furthermore reduced as the time during which the temperature of the addressed data bit in focus upon writing, has to stay above the glass transition temperature, is reduced.

1. A computer readable medium for optical storage of data comprising,
an LC layer, including
a first type of liquid crystal molecules aligned in one direction and forming a polymer network, and
a second type of liquid crystal molecules oriented in a second direction, in which the orientation of said second type of liquid crystal molecules is meta-stable.

2. A computer readable medium, according to claim 1, in which the LC layer contains 0.1-10% by weight of said first type of liquid crystal molecules, and 80-99.9% by weight of said second type of liquid crystal molecules.

3. A computer readable medium according to claim 1, comprising several LC layers.

4. A computer readable medium according to claim 3, in which at least one LC layer is pre-written with data.

5. A computer readable medium according to claim 1, in which the LC layer contains fluorescent dye molecules.

6. Method for producing a computer readable medium for optical storage of data, comprising the steps of:
applying, onto a substrate, a mixture comprising a first type of liquid crystal molecules and a second type of liquid crystal molecules, said second type of liquid crystal molecules being associated with a glass transition temperature, for providing a glassy LC layer,
heating the liquid crystal layer to a temperature above the glass transition temperature,
providing alignment of the liquid crystal molecules in a first direction,
supplying radiation to the LC layer in order to form a liquid crystal polymer network of the first type of liquid crystal molecules,
applying an electric or magnetic field to the LC layer causing orientation of the second type of liquid crystal molecules in a second direction, and
cooling the LC layer to a temperature below said glass transition temperature during the application of said electric or magnetic field, so that a meta-stable state of orientation of liquid crystal molecules is established in said medium.

7. Method for producing a computer readable medium for optical storage of data according to claim 6, for which the mixture applied comprises fluorescent dye molecules.

8. Method for producing a computer readable medium, according to claim 6, for which said computer readable medium comprises several LC layers.

9. Method for producing a computer readable medium, according to claim 8, in which writing of data is performed in at least one layer.

10. Method for producing a computer readable medium, according to claim 9, wherein more than one bit area is heated simultaneously by applying a pre-patterned hot stamp.

11. Method for producing a computer readable medium for optical storage of data according to claim 6, in which the step of providing alignment, includes application of an alignment layer onto said substrate prior to applying said mixture of liquid crystal molecules.

12. Method for producing a computer readable medium for optical storage of data according to claim 6, in which the step of providing alignment, includes the usage of an external electric field applied to the LC layer.

13. Method for producing a computer readable medium for optical storage of data according to claim 6, in which the step of providing alignment, includes the usage of an external magnetic field applied to the LC layer.

14. Method for producing a computer readable medium for optical storage of data according to claim 6, in which the radiation supplied in order to form at least one liquid crystal polymer network, is electromagnetic radiation and one of UV-light, X-ray or gamma rays.

15. Method according to claim 6, in which the radiation supplied is an electron beam radiation.

16. Method according to claim 6, wherein the first type of liquid crystal molecules are reactive and the second type are non-reactive liquid crystal molecules.

17. Method according to claim 6, in which the step of heating includes heating to a temperature above the glass transition temperature, T_{g}, and below the clearing temperature, T_{c}.

18. Method of writing data into a computer readable medium according to claim 1, comprising the following step,
for every bit area in a LC layer to be written,
applying a heat pulse to said bit area in the LC layer, such that the temperature, T, of said area becomes higher than the glass transition temperature, T_{g}, of the second type of LC molecules in said bit area.

19. Method of writing data according to claim 18, wherein the application of a heat pulse to the bit area is performed by focussing a short laser pulse in said bit area.
